(19) United States
(12) Patent Application Publication
(10) Pub. No.: US 2004/0053044 A1
(43) Pub. Date: Mar. 18, 2004

(54) Conformable, thick edge adhesive tape for rough surface applications

(75) Inventors: Roberto C. Moreno, St. Paul, MN (US); Gary W. Maier, Roberts, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/246,355

(22) Filed: Sep. 18, 2002

(51) Int. Cl. B32B 7/12; B32B 15/04

(52) U.S. Cl. 428/343; 428/354

(57) ABSTRACT

Described is a pressure sensitive adhesive tape having a backing with a first side and a second side and an adhesive or segments of adhesive on the first side where the adhesive at the edges is thicker than the mid-cross section. Such tapes are especially useful on rough surfaces. Also described is an adhesive tape with an inner adhesive coated on the first side, a plurality of second segments uncoated by adhesive, where the first segments are separated by the second segments, and a third segment of an edge adhesive coated on the edges of the first side of the tacking providing a thicker edge adhesive.

### FIELD OF THE INVENTION

The present invention relates to adhesive tapes particularly useful for rough and non-ideal surfaces where the adhesive tape has a conformable, thicker edge(s).

### BACKGROUND OF THE INVENTION

Conventional adhesive tapes, such as box sealing tape, are formed with a backing layer, an adhesive layer, and a low adhesion backsize layer (LAB). These pressure-sensitive adhesive tapes are usually prepared by a process in which a layer of pressure-sensitive adhesive is applied to one major surface of the backing layer across the entire width of the backing layer, and a layer of LAB is applied to the other major surface of the backing layer. Some preferred adhesives include rubber-based adhesives which include a blend of natural or synthetic rubber and tackifier resin. Styrene-isoprene-styrene block copolymer based adhesives are often used. Acrylate-based adhesives are also used.

### SUMMARY OF THE INVENTION

The present invention provides a pressure-sensitive adhesive tape that can be obtained by coating or otherwise placing a thicker layer of a pressure sensitive adhesive (PSA) at an edge or edges of a tape than the adhesive coat or layer at other points of the mid cross-section of the tape. Optionally, the tape may feature a strip of foam or another conformable material or combination of materials at the edge or edges of a tape, resulting in a thicker layer than the adhesive coat or layer at other points of the mid cross-section of the tape. Also, the tape may or may not contain one or more adhesive coats or strips in its mid-section. Additionally, the adhesive at the edges may or may not be of the same chemical composition as that of the adhesive or adhesives in the mid cross-section of the tape. In addition, a pattern can be imprinted on the adhesive strips. The pattern can be formed by microstructuring or other means. The pattern is intended to make the tape more conformable to discontinuous surfaces.

Accordingly, the present invention is an adhesive tape including a backing having a first side and a second side; and an adhesive coated on the first side of the backing, said adhesive including an inner adhesive and an edge adhesive, wherein the edge adhesive is thicker than the inner adhesive.

In another embodiment, the present invention is an adhesive tape comprising a backing having a first side and a second side; a plurality of first segments of an inner adhesive coated on the first side of the backing; a plurality of second segments uncoated by adhesive, wherein the plurality of first segments are separated by the plurality of second segments; and a third segment(s) of an edge adhesive coated on the edges of the first side of the backing, wherein the edge adhesive is thicker than the inner adhesive.

In conventional tapes, the thickness of the adhesive layer or coat is constant throughout the cross section of the tape. In the present invention, its main feature is to provide a thicker coat or strip of adhesive at the edges of the tape than the adhesive coat or layer in the mid cross-section of the tape. This feature allows the tape to conform better to the substrate's surface, thus providing equal or better edge seal than conventional tapes of the same edge thickness and equal or greater adhesion to the substrate. Also, this feature allows the adhesive strip at the edges of the tape to protect the adhesive(s) in the mid section of the tape from sun rays, solvents or other agents that may affect the performance of the inner adhesive(s). Additionally, the thick adhesive edge makes this invention perfect to mask baseboard, which is a difficult surface to mask due to its thin edge.

Another feature of this invention is to provide a masking tape that demonstrates good adhesion to a rough or non-ideal substrate at a lower coating weight compared to a masking tape with substantial coverage of adhesive coating on the adhesive surface of the masking tape.

Still another feature of this invention is to provide an adhesive that will adhere well to rough surfaces when the adhesive tape of the current invention is applied to such surfaces as a masking tape to prepare for painting, water proofing, marine varnishing, black top sealing, concrete sealing, concrete and pavement marking, and the like. The tape remains adhered when high pressure air or water is used to clean the surface prior to such operations.

A further feature of this invention is to provide a masking tape for rough or non-ideal substrates that will provide sharp boundary lines between masked and unmasked areas upon application of paint or coating on non-ideal or rough surfaces.

### BRIEF DESCRIPTION OF THE DRAWINGS

FIG. 1 is a cross-sectional view of adhesive masking tape according to one embodiment of the present invention.

FIG. 2 is a cross-sectional view of adhesive masking tape according to another embodiment of the present invention.

FIG. 3 is a cross-sectional view of adhesive masking tape according to another embodiment of the present invention.

FIG. 4 is a cross-sectional view of adhesive masking tape according to still another embodiment of the present invention.

FIG. 5 is a cross-sectional view of a wide adhesive tape prior to slitting.

### DETAILED DESCRIPTION

The invention is an adhesive tape, particularly a masking tape, with pressure sensitive adhesives. The tape contains a thicker layer of a pressure-sensitive adhesive (PSA) on both edges of the tape, than the adhesive coat or layer at other points of the mid cross-section of the tape. The edge portion of the tape is referred to as the edge adhesive and the mid cross-section of the tape containing adhesive is referred to as the inner adhesive. Both adhesives may be the same chemical composition or different.

A rough substrate is defined as a substrate whose surface is such that points of contact thereon cannot provide enough area to adhere to. The points of contact are only a portion of the total surface due to cavities, voids, holes, depressions or discontinuities on a surface; such as, for example, cement block, brick, bare unfinished wood, stucco, and the like.

A non-ideal substrate is defined as a substrate placed in a difficult area to be adhered to, such as, for example, a baseboard, window frames, door frames, and the like.

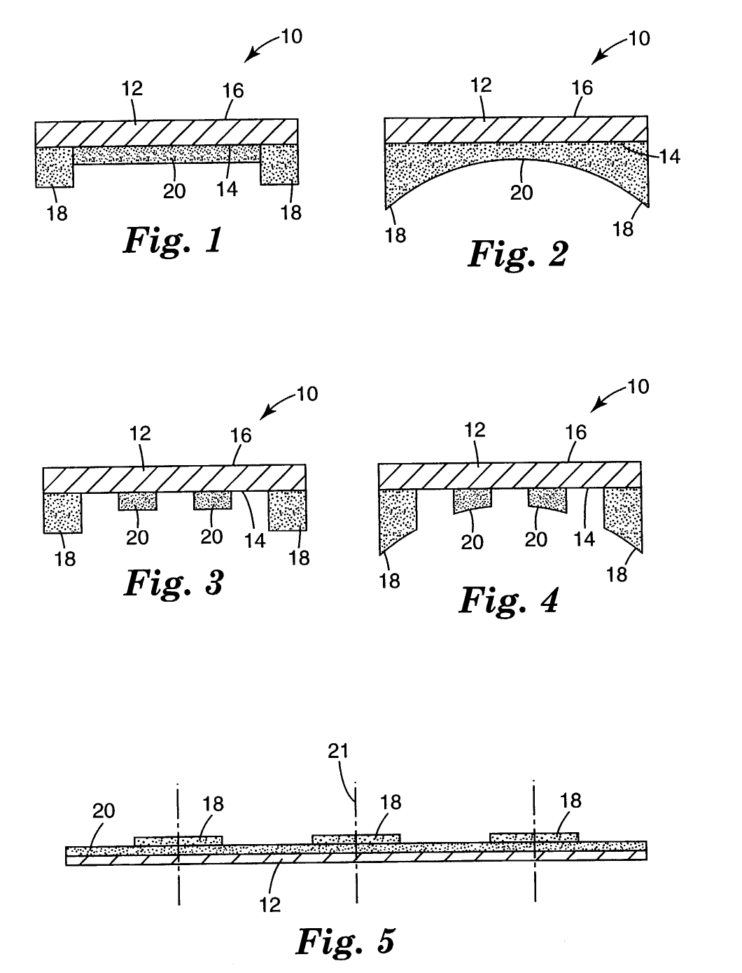

Referring to FIGS. 1 and 2, these illustrate the above embodiment where the entire side of the backing is covered having an adhesive with a thicker portion of adhesive at the edges and where the adhesive may be the same or different. FIGS. 1 and 2 show the tape 10 having a backing 12 where the backing has a first side 14 and a second side 16. On side 14, coatings or strips of adhesive are applied where the edge or edges of the tape have thicker layers of adhesive 18, the edge adhesive, than the mid cross-section of the tape 20, the inner adhesive. In one embodiment, the edge adhesive may be at least 25% thicker than the inner adhesive. Typically, the edge adhesive can have a width from about 0.01 to about 5 cm and a thickness from about 5 to about 50 mm (2 to about 20 mils).

In a second embodiment of the present invention, there is provided an adhesive tape having segments of adhesive. A segment is defined as any discrete portion. Segments include dots, blobs, and stripes, and can have any shape. A stripe is a long narrow band. It can be continuous or discontinuous. It can be linear or non-linear, such as annular or curved.

This embodiment is best illustrated by referring to FIGS. 3 and 4 that show a tape 10 with a backing 12 and sides 14 and 16. On side 14, segments containing adhesive are 18 and 20. The plurality of first segments is shown as 20 and is an inner adhesive. A plurality of second segments is illustrated by the lack of adhesive, the empty space between 20 and 18 in FIGS. 3 and 4. These second segments are uncoated by adhesive and are as shown clearly separated from the first segments. A third segment(s) on the edge of the tape is the edge adhesive 18 which clearly appears thicker than the inner adhesive 20.

In this embodiment, adhesives again may be the same or different.

The present invention which has a conformable, thick adhesive edge is particularly useful as a masking tape for rough surfaces. In the use of this invention less adhesive results in greater adhesion than a conventional tape where, for example, 100% of adhesive would provide 100% of adhesion.

The backing layer can be any known material used for backing layers for a particular tape. For example, the backing layer is any material (which can be a single composition or a blend of materials) or layers of materials that are used for tapes, such as, for example, duct tapes, electrical tapes, metallic tapes and masking tapes. The backing layer can be, for example, cloth, paper, metal foil, or plastic film. Suitable paper backings include saturated and unsaturated flatstock and crepe. Suitable plastic film backings include polypropylene, polyethylene, copolymers of polypropylene and polyethylene, polyesters, and vinyl acetates. The polypropylene can be cast film, monoaxially oriented polypropylene (MOPP), biaxially oriented polypropylene (BOPP) or simultaneously biaxially oriented polypropylene (SBOPP). The backing material can be compostible, degradable, colored, printable, printed, and can be of different surface textures or embossed or extensible.

The adhesive can be virtually any adhesive. The adhesive can include hot melt-coated formulations, transfer-coated formulations, solvent-coated formulations, and latex formulations, as well as laminating, thermally-activated, and water-activated adhesives and bonding agents. Useful adhesives according to the present invention include all pressure sensitive adhesives. Pressure sensitive adhesives are well known to possess properties including: aggressive and permanent tack, adherence with no more than finger pressure, and sufficient ability to hold onto an adherend. Examples of adhesives useful in the invention include those based on general compositions of polyacrylate; polyvinyl ether; diene rubber such as natural rubber, polyisoprene, and polybutadiene; polyisobutylene; polychloroprene; butyl rubber; butadiene-acrylonitrile polymer; thermoplastic elastomer; block copolymers such as styrene-isoprene and styrene-isoprene-styrene (SIS) block copolymers, ethylene-propylene-diene polymers, and styrene-butadiene polymers; poly-alpha-olefin; amorphous polyolefin; silicone; ethylene-containing copolymer such as ethylene vinyl acetate, ethylacrylate, and ethyl methacrylate; polyurethane; polyamide; epoxy; polyvinylpyrrolidone and vinylpyrrolidone copolymers; polyesters; and mixtures or blends (continuous or discontinuous phases) of the above. Additionally, the adhesives can contain additives such as tackifiers, plasticizers, fillers, antioxidants, stabilizers, pigments, diffusing materials, curatives, fibers, filaments, foaming agents, and solvents. Hot melt adhesives are preferred as the edge adhesive and for adhesive segments. Also, each adhesive segment can be formed of multiple components of continuous phases; that is, in a single segment there can be different materials side-by-side. Also, the adhesive optionally can be cured by any known method.

An optional embodiment of the present invention is the use of foam strips or films as part of the pressure sensitive adhesive. The foam strips may be applied at an edge or edges of a tape anchored by means of an adhesive or as part of the inner adhesive, or an adhesive layer covering the entire front side of the backing as a continuous or discontinuous layer. Another way to lay the foam on the first side of the backing is by preforming a foamed adhesive which can bond itself to the backing and to the final adhesive layer. Still another method to prepare foam strips is by preparing an adhesive tape using a backing of a foamed material in a continuous or discontinuous layer. The adhesive tape is cut into strips which are applied to the backing of the final tape. The final adhesive is then applied to cover the bare side of the foam In a particular embodiment, the foam strip is included at the edges of the first side of the backing of the tape so that along with the adhesive layer to attach the foam strip, the edge is thicker than the mid-section of the tape. A particularly useful foam strip is a closed cell, polyethylene foam.

A general description of useful pressure sensitive adhesives may be found in Encyclopedia of Polymer Science and Engineering, Vol. 13, Wiley-Interscience Publishers (New York, 1988). Additional description of useful pressure sensitive adhesives may be found in Encyclopedia of Polymer Science and Technology, Vol. 1, Interscience Publishers (New York, 1964).

If required, any known low adhesion backsize layer, hereinafter LAB, materials can be used. Suitable materials for the LAB layer include polyurethanes, silicones, fluorochemicals, acrylates, polyvinylacetates, and combinations thereof Numerous other layers can be added to the tape, such as primers to increase the adhesion of adhesive layer to backing layer. Also, printed material can be located on the first side of the backing layer under the adhesive, or on the second side of the backing layer either under, within, or over any LAB layer. This printed material can be advertising, instructions, or other information. The tape can contain a wide variety of additives such as deodorants, perfumes, antistatic materials, imaging and indicating materials, and encapsulated cleaning chemicals. Also, the backing layer can be modified by flame treatment, flame perforation, corona treatment, and roughening.

In the embodiment shown in FIGS. 3 and 4, the adhesive is applied in narrow lanes or segments 20 and 18 separated by narrower uncoated segments. The coated adhesive segments 20 and 18 can be 1.27 cm (0.50 in) wide and the uncoated segments can be 0.025 cm (0.010 in) wide creating a ratio of stripe width to uncoated lane width of 50:1. This ratio can be as low as 2:1 and in some embodiments the ratio can be even lower or the width of the stripes can be less than that of the uncoated lanes. The ratio may vary from about 2:1 to about 10:1. In one embodiment, there are 100 segments per 15.24 cm (100 per 6 in). More or fewer segments can also be used.

The width of the adhesive segments can range from 0.01 to 1.0 cm and the width of the uncoated portions of backing between adjacent segments of adhesive can range from 1.0 cm to 0.0 cm, depending on the coating weight and processing conditions (such as the distance between coating plate orifices and the extent of segment flattening, which is discussed below).

After the tape is coated, the adhesive segments may be flattened. Flattening can be performed, for example, using a roller nip as explained in more detail below. In one embodiment, the flattened adhesive segments 20 can contact each other (the width of the uncoated portions is 0) to produce a corrugated appearance and to alter the performance characteristics of the tape 10.

Depending on the pattern and width of the adhesive segments 20 and 18 that are used, a segmented tape 10 according to this invention can significantly reduce the amount of adhesive used. This reduction is about 10-20% but can be as much as 30%. This reduces the cost to make the tape, in addition to providing a unique and visually stimulating product. The ribbed pattern provides a reinforced appearance to the tape. Another advantage is that any streaks that may be generated during the coating of the adhesive do not detract from the appearance of the tape, as they do with fully adhesive-coated tapes.

The adhesive tape of the present invention may be prepared by a number of methods. One method uses a conventional tape to which an adhesive is added to its edge or edges by adding a strip of adhesive by extrusion or similar means. Another method is by coating a layer of adhesive on a release liner and then folding the edges of the adhesive layer over itself to increase the thickness of the adhesive edge (which depending on the way it is folded could be any multiple of the original thickness). Another method to create this invention is by extruding an adhesive using a die in which orifices have been opened as to allow the build up of adhesive in desired areas of the tape, such as on the edges. Still another method involves coating a thick layer of adhesive onto a backing and using an embossing roll that can be used to modify the adhesive's thickness as to impart the tape the desired distribution of adhesive to obtain a tape like the one described herein.

In conventional tapes, the thickness of the adhesive layer is constant throughout the cross section of the tape; thus, when the tape is pressed down onto the substrate, the force used to place the tape is distributed over a large area of the tape. However, the present invention allows the concentration of that force at the edges or wherever the adhesive is concentrated. Hence, by concentrating the force at the edges the adhesive is more easily pressed into the cavities and depressions of the substrate's surface; thus, creating a better edge seal and better bonding or adhesion of the adhesive to the substrate.

In situations in which a good edge seal is desired, a tape with a uniform thick layer of adhesive may be a viable approach. However, because this invention renders equally good or better edge seal and adhesion than a conventional tape of the same thickness, savings on the amount of adhesive are envisioned.

A particularly useful application of the present invention is in painting non-ideal substrates. Professional painters often need to apply masking tape to baseboard, but it is difficult to do because baseboard edges are thin; thus making it difficult for traditional tapes to adhere because of the reduced contact are& To solve this problem an aggressive tape or a tape with a thick adhesive is preferred. However, because this invention features a thicker adhesive edge, it offers an improved solution to this problem over conventional tapes.

Also, in certain applications it is desirable to mask certain areas while leaving others unmasked to be cleaned. In some of those situations, a high-pressure jet of air or water is used to clean the surface and conventional tapes are used to mask the desired areas. Nevertheless, when the jet of air or water is directed to the edge of the conventional tape, the tape peels off the surface. The tape described in this invention addresses this problem.

Another advantage of the present invention is the ability to use an adhesive at the edges of the tape to protect the adhesive(s) at the mid cross-section of the tape. For example, some low cost adhesives, such as KRATON™ and rubber based adhesives, adhere well to rough surfaces such as brick and cement blocks, but they degrade or transfer to the substrate when exposed to sunlight. This invention allows the use of these adhesives in the mid cross-section of a tape while a UV stable adhesive is used on the edges of the tape. Thus, the present invention allows for the construction of a tape that is UV resistant and of potentially lower cost than a tape made only with the UV-stable adhesive.

Still another advantage of this tape construction is that of a greater percent adhesion gained with respect to that of a traditional tape (100% adhesive, 100% adhesion) which features the same adhesive type. For example, the adhesion for a tape described here that contains 50% of the adhesive of a traditional tape with the same adhesive coat thickness would be expected to be 50% of that of the traditional tape. However, the adhesion for the tape described in this invention will be at least equal if not greater than the expected one. This results in better utilization of the adhesive.

### EXAMPLES

The examples below intend to illustrate but not limit the present invention as it is envisioned for paint masking applications.

### Example 1

A masking tape strip 50-cm long and 2.54-cm wide was prepared as follows. First, a layer of polyalphaolefin (PAO) adhesive was extruded from a die onto a release liner. The extruded adhesive layer was 0.023 cm (6 mil) thick and approximately 15.24 cm wide. Then, 50-cm-long pieces of the extruded adhesive on the release liner were cut and placed on a flat surface with the adhesive side up. The exposed adhesive was covered with a new piece of release liner as to “sandwich” the adhesive layer between the two pieces of release liners. With the aid of a slitter (a knife featuring two razor blades separated 0.3175 cm from each other), strips of adhesive 0.3175 cm wide and 50-cm long were cut. FIG. 5 illustrates a slitting process.

Each of the adhesive strips used to make the tape samples in Table 1 were one-eighth the width of the tape. Thus, for the tape labeled B, which featured four strips of adhesive (one adhesive strip on each edge and two strips evenly spaced in the middle) the amount of adhesive would be ½ (4×⅛) the amount of adhesive in the reference tape A. Similarly, for the tape labeled D, which featured only two strips of adhesive (one adhesive strip on each edge of the tape) the amount of adhesive would be ¼ (2×⅛) the amount of adhesive in the reference tape A. Additionally, the tape labeled D featured a strip of 0.038-cm thick, closed cell, polyethylene foam. Prior to the placement of the foam strip at the edge of the tape, a strip of an acrylic, transfer adhesive of 0.003 cm thick was applied at the edge of the tape to hold the foam strip in place. Then the 0.023 cm thick adhesive strip was placed on top of the foam strip. There is a similar relationship among the rest of the tape samples within each adhesive thickness.

The control masking tape was prepared by covering with adhesive the full 2.54-cm width and length of the paper. The 2.54 cm wide strips were applied to a 2.54 cm wide polyethylene film backing primed with Serfene 2024B Primer from Rohm and Haas by removing one side of release liner and pressing on the paper backing. This represented the reference sample identified as A single layer control or reference sample in Table 1. To ensure good bonding of the adhesive strips to the film, a 1.68+/−0.37 kg steel cylinder, which is described in the test method for the Adhesion to Cement Block, was rolled over the tape samples as to ensure good contact between the adhesive and the primed film. To double and quadruple the thickness as in F and K controls, the full width of the 2.54 cm backing was covered with two and three layers of adhesive, respectively. To make the samples with discrete strips of adhesive the 0.3175 wide strip of adhesive was applied by removing the release liner to expose the adhesive and adding the 0.3175 strip to appropriate areas of the 2.54 cm backing to make the samples B, C, D and E. This was repeated to make several layers of adhesive strips in samples G, H, I, J, K and L.

TABLE 1

| Description of Tape Construction | Tape | Amount of |
|---|---|---|
| (Placement of the adhesive strips | Sample | Adhesive |
| across the tape width) | Identification | (%) |
| One continuous layer of adhesive | A | 100 |
| | | (Reference) |
| Adhesive strip on edges and two adhesive | B | 50 |
| strips evenly spaced in the midsection | | |
| One strip of foam and strip of one- | C | 50 |
| adhesive-layer on edges and one one- | | |
| adhesive layer strip in the middle | | |
| One strip of foam and one strip of one- | D | 25 |
| adhesive layer on edges | | |
| One strip of foam on edges and a | E | 100 |
| continuous layer of adhesive | | |
| Two continuous layer of adhesive | F | 100 |
| | | (Reference) |
| Two-layer adhesive strip on edges and | G | 31 |
| one two-adhesive layer strip in the middle | | |
| Two-layers adhesive strip on edges and | H | 38 |
| two two-adhesive layer strips evenly | | |
| spaced in the middle | | |
| A continuous adhesive layer and an | I | 63 |
| additional adhesive strip on edges | | |
| One layer of foam and two of adhesive on | J | 50 |
| edges, two strips of two layers in the | | |
| middle | | |
| Three continuous adhesive layers | K | 100 |
| | | (Reference) |
| Three-layer adhesive strip on edges, one | L | 33 |
| two-adhesive layer strip in middle | | |

### Example 2

This example describes the paint masking characterization test.

A cement block (19-cm×40-cm×3.8-cm from Menards or Home Depot Hardware Stores, St. Paul, Minn.) was laid flat on a work bench and with a regular paintbrush dust and debris were removed. A primer (Prep Rite Latex Primer 600-7447 White B28 W200 from Sherwin Williams, St. Paul, Minn.) was applied to all the upper surface of the cement block. The primer was allowed to dry overnight. Parallel 2.5 cm wide by 25 cm long masking test strips from Example 1 were applied to the width of the primed block. Each strip was laid on the block, then a steel roll was passed over the test tape twice at a speed of about 305 cm per minute. The steel cylinder was 3.5 cm wide and 14.0 cm in diameter, and was made of bare stainless steel. The surface was a true cylinder and the weight of the roller was 5040 grams. A space of about 0.635 cm was allowed between the strips. These steps were repeated for each test strip while sample numbers were marked to identify them on the block.

Latex paint (Pittsburgh Paints Semi-gloss Latex 78-851 Black) was applied covering all exposed areas of the primed block by using a regular paintbrush from Menards Hardware Store. The paint was allowed to dry overnight. The strips were removed from the block. The block was visually inspected to assess the quality of the paint lines obtained with the various test masking strips.

To characterize the quality (sharpness) of the paint lines a 10-cm wide mid-section of the painted cement block was selected; i.e., two 10-cm long paint lines for each test tape (two paint lines since each tape when painted over it produced two paint lines, one from each edge). Then, the number of ridges or protrusions of paint were counted off the base of the paint line and reported each of them in one of three categories: 0-0.15 cm; 0.15-0.3 cm; or >0.3 cm. Once the ridges were categorized, a weight (number of points) to each category was assigned. For the ridges in the category 0-0.15 cm, 1 point each was assigned; for the ridges in the 0.15-0.3 cm category 3 points each was assigned; and for the ridges in the >0.3 cm category five points each was assigned.

Using this system points of references were established; i.e., a perfect paint line, zero points; and a worst paint line. For the worst paint line, the number of points were (20 cm/0.15 cm)×6 points=667 points. With this system an average number of points for each tape construction was estimated.

Since the number of points for each paint line actually suggests how poor the paint line is, or its departure from a perfect paint line, it allowed the estimation of the degree of “sharpness”, or “perfection” of each paint line. The calculation was done as follows:

Paint line % Sharpness=[1−average number ofpoints/667]×100

The rating of the paint lines produced with the test tapes are summarized in Table 2. The results show that for each adhesive thickness, the tape samples with the thicker adhesive on the edge produce superior paint lines to those produced with conventional tape constructions (the ones with the continuous layer of adhesive) and have a better paint line rating; i.e., a higher paint line sharpness. Similar results were obtained for the tapes featuring the strip of foam and the adhesive strip on the edges. This is one of the advantages of the current invention.

TABLE 2

| Tape | Amount | | % | | | |
|---|---|---|---|---|---|---|
| Sample | of | Adhesion to | Dif- | Paint Line | % | |
| Identifi- | Adhesive | Cement | fer- | Sharpness | of PL | % |
| cation | (%) | Block (%) | ence | (%) | Sharpness | Diff. |
| A | 100 | 32.8 | 0 | 64 | 100 | 0 |
| | (Ref- | | | | | |
| | erence) | | | | | |
| B | 50 | 21.3 | 15 | 86 | 134 | 84 |
| C | 50 | 19.3 | 9 | 91 | 142 | 92 |
| D | 25 | 15.5 | 22 | 88 | 137 | 112 |
| E | 100 | 29.7 | −9 | 93 | 145 | 45 |
| F | 100 | 51.9 | 0 | 79 | 100 | 0 |
| | (Ref- | | | | | |
| | erence) | | | | | |
| G | 31 | 21.0 | 9 | 88 | 111 | 80 |
| H | 38 | 27.6 | 16 | 87 | 110 | 72 |
| I | 63 | 36.3 | 7 | 81 | 103 | 40 |
| J | 50 | 26.6 | 1 | 88 | 111 | 61 |
| K | 100 | 52.0 | 59 | 81 | 100 | 0 |
| | (Ref- | | | | | |
| | erence) | | | | | |
| L | 33 | 25.3 | 44 | 92 | 114 | 80 |

### Example 3

This example describes the test conducted to determine the adhesion to a cement block of the masking test tape of Example 1. For this test, a bare cement block like the one used in Example 2 was used. The cement block was cleaned, first with a regular paint brush and then cleaned with a moist towel to remove any traces of dust. The block was left overnight in room at a constant temperature and humidity of (70F and 50% R.H.).

For testing the adhesion of the tape samples to the cement block, a three-centimeter wide, and 30.5-cm long strip (free of dirt and cracks) of the cement block was selected. The tape samples were applied to the cement block in this area. This was done to ensure all test tapes were applied to the same test area and in this way the variation in adhesion to cement block due to the variations on the surface of the cement block was minimized.

To assess the adhesion of the tape samples to the cement block, a 30.5-cm long by 2.5-cm wide strip specimen was cut from the masking tape of Example 1. While holding the specimen in one hand, the operator positioned the specimen above the test block and above the selected test area, so the long edge of specimen was parallel to the long side of the block, and one end of the specimen was positioned at one end of the block. A steel roll was passed manually starting at the end of the specimen already adhered to the cement block while holding the other end with the free hand. Tension was kept to allow the roller to cause the application. The motion of the cylinder was back and forth at a speed of about 305 cm per minute. The steel cylinder was 8.25 cm in diameter and 4.44 cm thickness, having a shore scale durometer hardness of 80+/−5. The surface was a true cylinder and the weight of the roller was 1.68+/−0.37 kg.

A Thwing-Albert Tensile Tester, Model 225-1 was used to determine 180 Degree adhesion to Cement Block at 12″/min. The test was described in (Instron) Adhesion to Steel TM-613. “Back” button was pressed in the peel tester to position the head for testing mode. The end of the tape was attached (the one that would allow the 180 degree peel) to an L-hook which was to be engaged to the moving head of the tensile tester and peeled approximately 2.5 cm of it from the panel as to have some tension on the tape. Motion was started. (This step was initiated within 1 minute of the completion of roll down, so as to make the test valid).

The test was performed at about 23+/−2 degrees C. and 50+/−5% relative humidity. The peel speed was 12″/min. Length of peel test was 30 seconds Pre-peel time was 2 seconds Peel distance was approximately 15.24 cm.

The results of the adhesion to cement block tests are in Table 2. In this table the tape strip labels correspond to the labels in Table 1.

The % adhesion for each of the tapes was calculated with respect to the reference tape for each adhesive thickness; i.e., the tape samples whose full width was covered with adhesive represented the conventional tape construction. For the examples described here, three points of reference were used. Point of reference 1, this reference point was represented by tape samples labeled A and were the tape samples in which the entire width was covered with one continuous layer of adhesive. Point of reference 2 was represented by tape samples labeled F, and were the tape samples in which the entire width of the tape was covered with two superimposed continuous layers of adhesive (i.e., doubling the adhesive thickness of 1). Point of reference 3 was represented by tape samples labeled K, and were the tape samples in which the entire width of the tape was covered with three superimposed layers of adhesive (i.e., tripling the adhesive thickness of 1).

The results shown in Table 2 clearly demonstrate that the adhesion for the test samples featuring two, three or four adhesive strips have a higher % of adhesion than corresponding sample in the reference tape containing corresponding adhesive thickness. This was unexpected, since a proportional amount of adhesion to the amount of adhesive in a given tape sample with respect to the corresponding reference tape was expected. In other words, 25% the adhesion of the corresponding reference tape for a tape that has 25% the amount of adhesive of the corresponding reference tape (same adhesive and same adhesive thickness) was expected. The results clearly show the adhesion gains with the current invention.

An exception to the above conclusion was tape sample labeled E. The % adhesion for this tape was lower than the adhesion for the corresponding reference tape A. This can be explained by the fact that the foam was stiffer than the adhesive and it did not allow the adhesive in the midsection of the tape to adhere to the cement block; however, the corresponding Paint Sharpness for this construction was among the highest.

1. An adhesive tape comprising:
a backing having a first side and a second side; and
an adhesive coated on the first side of the backing, said adhesive comprising an inner adhesive and an edge adhesive, wherein the edge adhesive is thicker than the inner adhesive.

2. The tape of claim 1, wherein the tape is a masking tape.

3. The tape of claim 1, wherein the edge adhesive is at least about 25% thicker than the inner adhesive.

4. The tape of claim 1, wherein the edge adhesive and the inner adhesive are pressure sensitive adhesives.

5. The tape of claim 1, wherein the edge adhesive and the inner adhesive are the same.

6. The tape of claim 1, wherein the edge adhesive and the inner adhesive are different.

7. The tape of claim 6, wherein the edge adhesive is a hot melt adhesive.

8. The tape of claim 6, wherein the edge adhesive is a UV stable adhesive.

9. The tape of claim 1, wherein the edge adhesive has a width from about 0.01 to about 5 cm.

10. The tape of claim 1, wherein the edge adhesive has a thickness from about 5 to about 50 mm.

11. The tape of claim 1, wherein the adhesive further comprises a foam material between adhesive layers.

12. The tape of claim 1, further comprising a low adhesion backsize layer on the second side of the backing.

13. The tape of claim 1, further comprising a pattern imprinted on the edge adhesive.

14. An adhesive tape comprising:
a backing having a first side and a second side;
a plurality of first segments of an inner adhesive coated on the first side of the backing;
a plurality of second segments uncoated by adhesive, wherein the plurality of first segments are separated by the plurality of second segments; and
a third segment(s) of an edge adhesive coated on the edge(s) of the first side of the backing, wherein the edge adhesive is thicker than the inner adhesive.

15. The tape of claim 14, wherein the edge adhesive and the inner adhesive are pressure sensitive adhesives.

16. The tape of claim 14, wherein the edge adhesive and the inner adhesive are the same.

17. The tape of claim 14, wherein the edge adhesive and the inner adhesive are different.

18. The tape of claim 14, wherein the ratio of the width of the first and third segments to the width of the second segments ranges from 2:1 to 10:1 and the width of the first and third segments ranges from 0.01 to 1.0 cm and the width of the second segments ranges from 1.0 to 0.0 cm such that when the width of the second segments is 0.0 cm the adjacent first and third segments contact each other to form a coating having a nonuniform varying thickness.

19. The tape of claim 14, wherein the edge adhesive further comprises a foam material between adhesive layers.

20. The tape of claim 14, further comprising a low adhesion backsize layer on the second side of the backing.

21. The tape of claim 14, further comprising a patter imprinted on the first and third segments.

22. The tape of claim 14, wherein the tape is a masking tape.
